(19) United States
(12) Patent Application Publication
(10) Pub. No.: US 2014/0009478 A1
(43) Pub. Date: Jan. 9, 2014

(54) IMAGE PROCESSING APPARATUS AND CONTROL METHOD

(71) Applicant: CANON KABUSHIKI KAISHA, Tokyo (JP)

(72) Inventor: Soichiro Suzuki, Kawasaki-shi (JP)

(21) Appl. No.: 13/934,269

(22) Filed: Jul. 3, 2013

(30) Foreign Application Priority Data
Jul. 4, 2012 (JP) 2012-150778

(51) Int. Cl. G06T 1/60

(52) U.S. Cl. CPC G06T 1/60
USPC 345/531

(57) ABSTRACT

Information showing multiple processes that perform a write of data with respect to memory is obtained, and at least one different storage area among multiple storage areas is allocated to each process for writing of data. Then, an information processing apparatus changes the number of storage areas allocated to the processes for data writing, according to the data lengths that can be continuously accessed by the processes without being interrupted by other processes.

### BACKGROUND OF THE INVENTION

1. Field of the Invention

The present invention relates to an image processing apparatus and a control method, and particularly to a technique for increasing the efficiency of memory access.

2. Description of the Related Art

In various devices, including image capturing devices such as cameras, a DRAM is used as a memory for temporary data storage. For example, in image capturing devices, image data acquired by still image capture, frames (image data) of moving image data acquired by moving image capture, and the like, are transferred to the DRAM and stored there.

The DRAM is divided into multiple areas called banks, which are the result of virtually dividing the memory area in the DRAM so as to support simultaneous access to the DRAM by multiple processes. A bank address (BA) is allocated to each bank, and furthermore a column address (CA) and a row address (RA) are allocated to memory cells, which are the smallest units inside of a bank. Access to the DRAM is performed by specifying this bank address, the row address, and the column address of a memory cell in which the head of data exists.

FIG. 8A shows command issue and data transfer status in a time series when performing a writing of data by sequentially changing the row address with respect to one bank in a DRAM. As illustrated, first, a bank address (bank B0) and row address at which data is written is designated, and a bank active (ACT) command is issued. A page designated by the row address of the bank B0 at which data is to be written is opened by the ACT command. At this time, the bank B0 changes from an idle state to a data write-enabled state. Then, at timing T2, a column address at which data is to be written is designated, and a write (WR) command is issued. Data to be written is transferred and written sequentially from the memory cell at the column address of the open page by the WR command.

After the data to be written that is of a predetermined length is transferred and written, at timing T3, a pre-charge (PRE) command is issued. The PRE command closes the open page, and the bank B0 enters the idle state again. The PRE command is a command that closes a page, and if access to a designated page at a different row address in the same bank is needed when one page is open, the PRE command needs to be issued. In the example in FIG. 8A, since writing of data is performed with respect to a page at a different row address at the next timing T4 and onward, the PRE command is issued at timing T3.

As is apparent from the diagram, access with respect to bank B0 cannot be performed while the PRE command or the ACT command is issued. In other words, if performing access while sequentially changing the row address with respect to one bank, the efficiency with which the DRAM is accessed decreases according to the number of times the row address is changed (number of page switch times).

In contrast to this, if performing data writing with respect to the DRAM while performing so-called interleaved access in which the bank is changed as in FIG. 8B, issue frequency of the PRE command (hereinafter referred to as pre-charge frequency) can be reduced. Specifically, since data is divided and written in multiple banks, the number of writing times with regard to one bank is smaller, and the pre-charge frequency can consequentially be reduced. Since the PRE command need only be issued while another bank is being accessed, writing of data can be performed without being influenced by a state in which a bank cannot be accessed due to the issue of a PRE command or an ACT command.

Various proposals have been made regarding methods for reducing the pre-charge frequency during access with respect to this kind of DRAM. Japanese Patent Laid-Open No. 2008-299438 discloses a method of controlling a writing of data such that data that in a block is stored at identical row addresses instead of in a raster scan pattern since blocks of past frames are referenced when decoding video encoded data.

However, reduction of pre-charge frequency by interleaved access is effective when one process continuously accesses the DRAM, but when multiple processes repeatedly access the DRAM alternatingly, sometimes the pre-charge frequency cannot be reduced.

For example, as shown in FIG. 9A, a case is considered in which one process A continuously accesses a DRAM. In FIG. 9A, after one row address of BANK 0 is accessed by A-1 and A-2, access is performed by A-3 and A-4 with respect to the same row address of BANK 1. After access is similarly performed up to BANK 7, the next row address of BANK 0 is accessed. In this type of case, as shown in FIG. 9A, BANK 0 enters an inaccessible state due to the issuing of a PRE command with respect to BANK 0 during the processing of A-3 for example, and the total access time does not change since it is a period in which access to BANK 0 cannot be performed.

On the other hand, as shown in FIG. 9B for example, a case is considered in which multiple processes B, C, and D repeatedly access the DRAM alternatingly. At this time, as shown in FIG. 9B, since row addresses that are alternatingly different in the BANK 0 are accessed, when the row address changes, it is necessary to issue a PRE command and an ACT command. In other words, even if one process accesses the DRAM while interleaving is being performed, the pre-charge frequency cannot be suppressed if access to a different row address by a different process occurs.

### SUMMARY OF THE INVENTION

The present invention has been achieved in view of these problems in the conventional art. The present invention provides an image processing apparatus and a control method that increase the efficiency of memory access by reducing the frequency with which pre-charge commands are issued.

The present invention in its first aspects provides an image processing apparatus for processing image data using a memory having a plurality of banks, comprising: a processing unit configured to output a plurality of image data pieces having differing data amounts; an allocating unit configured to allocate banks for storing the plurality of image data pieces output from the processing unit among the plurality of banks, the allocating unit allocating a different bank to each of the plurality of image data pieces; a requesting unit configured to issue write requests for the plurality of image data pieces, based on the banks allocated by the allocating unit; and a memory control unit configured to write the plurality of image data pieces to the memory according to the write requests issued by the requesting unit.

Further features of the present invention will become apparent from the following description of exemplary embodiments with reference to the attached drawings.

### BRIEF DESCRIPTION OF THE DRAWINGS

FIG. 1 is a block diagram that shows a functional configuration of a digital camera 100 according to an embodiment of the present invention.

FIG. 2 is a block diagram that shows an internal configuration of a transfer control unit 106 according to an embodiment of the present invention.

FIGS. 3A, 3B, and 3C are diagrams for describing data access timing that corresponds to a process according to an embodiment of the present invention.

FIGS. 4A and 4B are diagrams for describing a bank allocated for access by processes, and describing DRAM access timing of the processes.

FIG. 5 is a block diagram regarding an address control function of a DMAC according to an embodiment of the present invention.

FIG. 6 is a flowchart that illustrates a DRAM transfer sequence of a digital camera 100 according to an embodiment of the present invention.

FIGS. 7A and 7B are diagrams for describing access control of each process that uses a continuous access alert signal according to a variation of the present invention.

FIGS. 8A and 8B are diagrams for describing a timing chart of a writing of data to a generic DRAM.

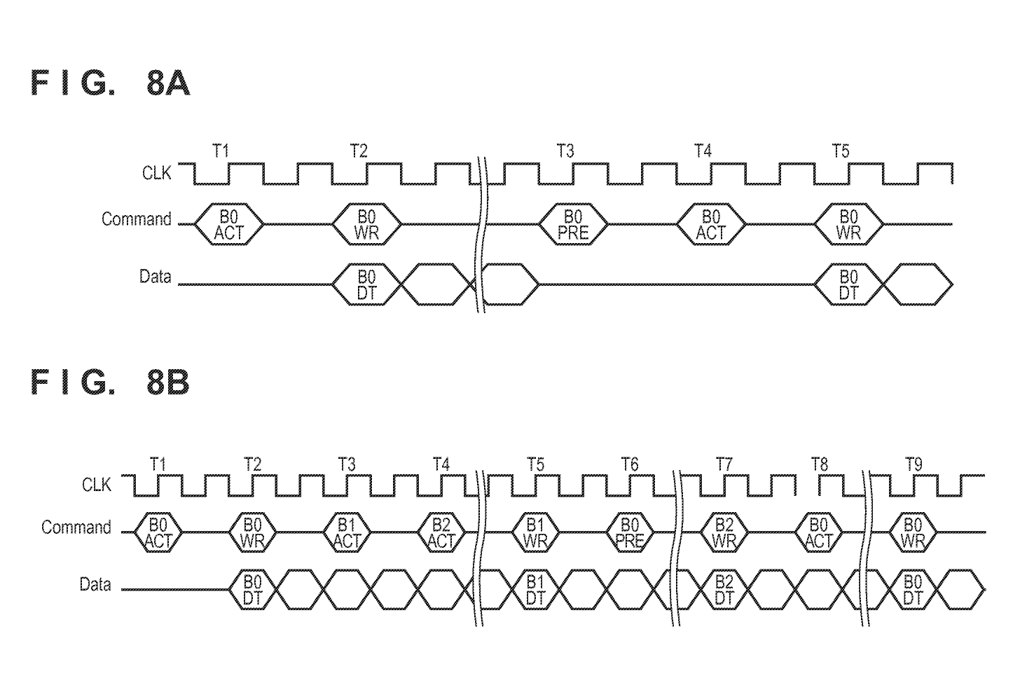

FIGS. 9A and 9B are diagrams for describing bank interleaved access to a generic DRAM.

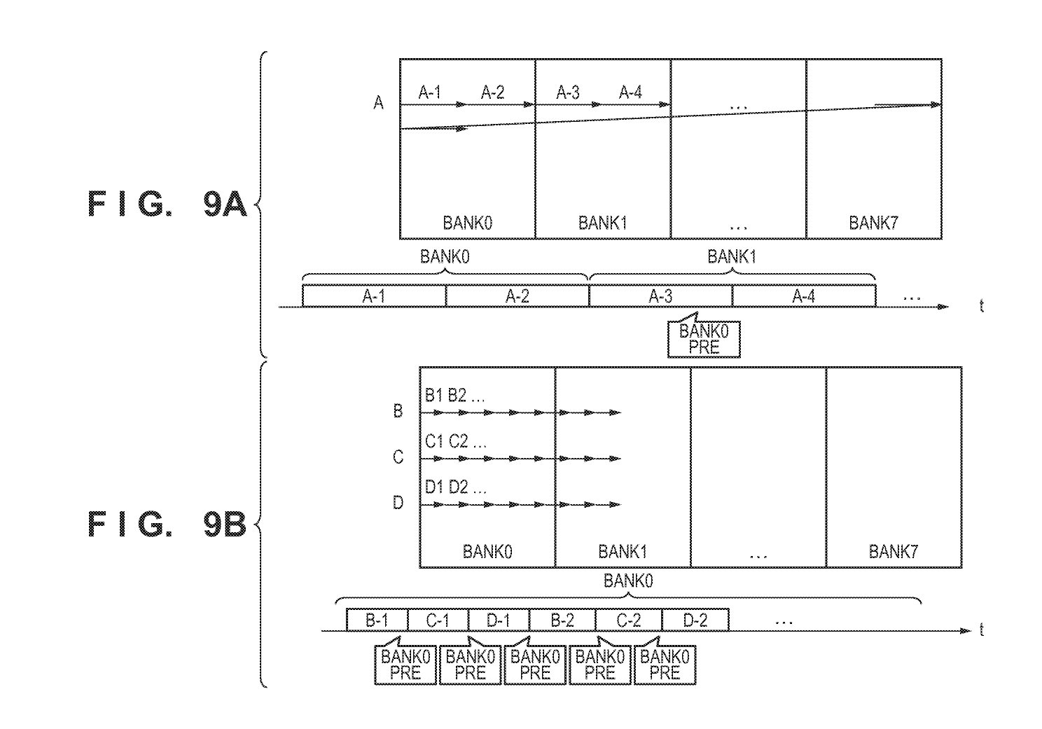

### DESCRIPTION OF THE EMBODIMENTS

Below, exemplary embodiments of the present invention will be described in detail with reference to the drawings. Note that one embodiment described below describes an example that applies the present invention to, as an example of an image processing apparatus, a digital camera that includes a DRAM and controls data transfer to the DRAM. However, the present invention can be applied to any device that can control data transfer to a DRAM.

Configuration of Digital Camera 100

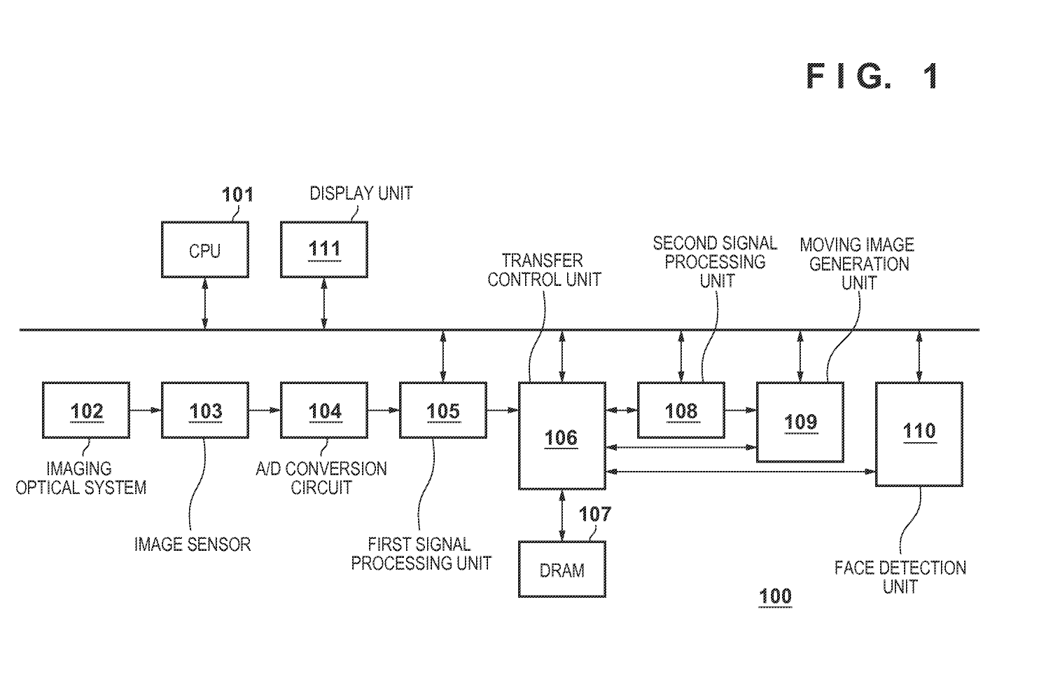

FIG. 1 is a block diagram showing a functional configuration of a digital camera 100 according to an embodiment of the present invention.

A CPU 101 controls the operation of blocks included in the digital camera 100. Specifically, the CPU 101 controls the operation of the blocks by reading out an operation program for each block stored in a ROM, which is not shown, extracting them to a RAM, which is not shown, and executing them.

An image sensor 103 is a CCD or CMOS sensor, or the like. The image sensor 103 photoelectrically converts an optical image that is formed on a light receiving surface by an imaging optical system 102, and outputs an acquired analog image signal to an A/D conversion circuit 104. The A/D conversion circuit 104 generates image data by applying A/D conversion processing to the output analog image signal.

A first signal processing unit 105 and a second signal processing unit 108 perform various image processes, such as noise reduction processing with respect to image data. In the present embodiment, the first signal processing unit 105 performs image processing relating to data to be written in a DRAM 107, and the second signal processing unit 108 performs image processing related to data to be read out from the DRAM 107. Additionally, a moving image generation unit 109 generates moving image stream data from image data output from the A/D conversion circuit 104.

A transfer control unit 106 controls writing to and readout from the DRAM 107. Specifically, the transfer control unit 106 performs writing of data output from the first signal processing unit 105 to the DRAM 107, or readout of data from the DRAM 107 to be used in the second signal processing unit 108, by issuing the corresponding commands to the DRAM 107.

A face detection unit 110 detects a person's face in a frame of image data written in the DRAM 107 or moving image stream data. Specifically, the face detection unit 110 reads out image data for face detection that has a predetermined number of pixels from the DRAM 107, and determines whether or not the pattern of a human face is included in the image data.

A display unit 111 is a display device included in the digital camera 100 such as an LCD. Image data and moving image data generated by the second signal processing unit 108 or the moving image generation unit 109 is displayed on the display unit 111.

Internal Configuration of Transfer Control Unit 106

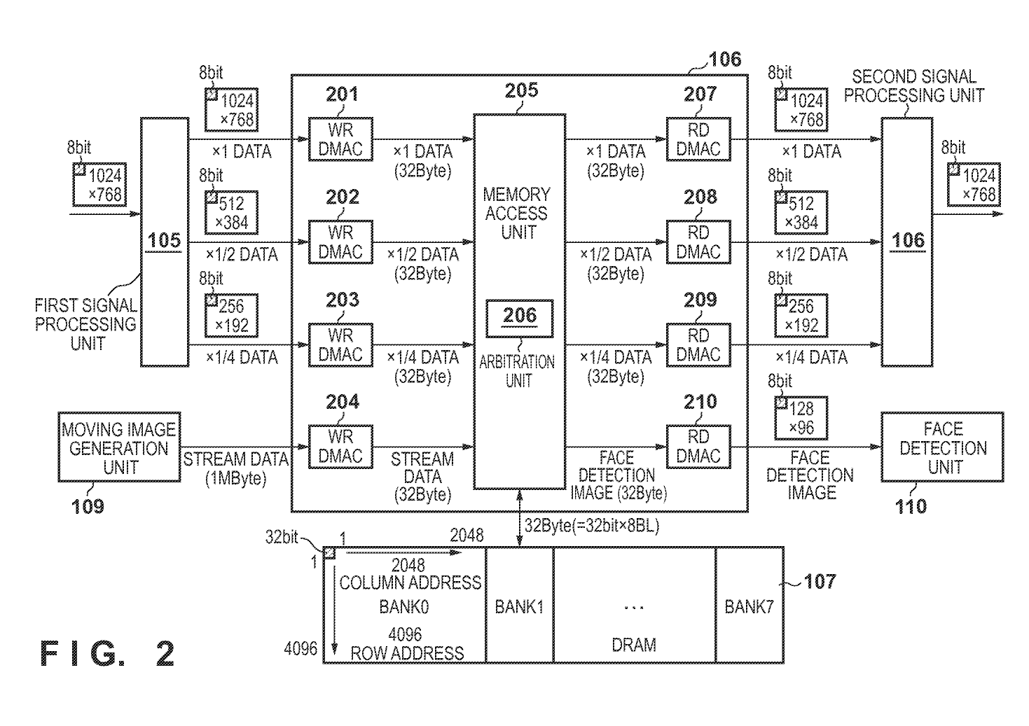

Here, the internal configuration of the transfer control unit 106 of the present embodiment will be described in further detail with use of FIG. 2. Note that the DRAM 107 of the present embodiment includes eight banks (storage areas) whose bank addresses are BANK 0 through BANK 7, and supports eight-burst transfer. Each bank has 2048 column addresses (CA 1 through CA 2048) and 4096 row addresses (RA 1 through RA 4096). Additionally, each memory cell (one word) has a capacity of 32 bits.

When an image capture is performed in the digital camera 100, the first signal processing unit 105 generates image data of three types (×1 data, ×½ data, ×¼ data) from image data output by the A/D conversion circuit 104. The three types of image data are each as follows:
×1 data: image data identical to the input image data
×½ data: image data acquired by downsampling the input image data to ½ in the horizontal and vertical directions
×¼ data: image data acquired by downsampling the input image data to ¼ in the horizontal and vertical directions

In the present embodiment, the A/D conversion circuit 104 outputs image data with 1024×768 pixels, each pixel (sample) has an information capacity of eight bits. That is to say, the number of pixels of the above-mentioned three types of image data is 1024×768 pixels for ×1 data, 512×384 for ×½ data, and 256×192 for ×¼ data.

The three types of image data are transmitted to the transfer control unit 106 on mutually different lines, and are input to a WRDMAC (Write Direct Memory Access Controller) 201, a WRDMAC 202, and a WRDMAC 203 respectively. The WRDMACs 201 through 203 output the input image data to the memory access unit 205 in units of 32 bytes (=32 bits×8 bursts) in order to perform eight-burst transfer with respect to the DRAM 107.

Additionally, the moving image stream data that is generated by the moving image generation unit 109 is transmitted to the transfer unit 106 on another line, and is input to a WRDMAC 204. In the present embodiment, the moving image generation unit 109 outputs one megabyte (=1024×1024 bytes) of moving image stream data to the WRDMAC 204 in the transfer control unit 106.

After each WRDMAC receives address information of a write destination on the DRAM 107 from the CPU 101, and 32 bytes-worth of data is input in eight-burst transfer units, the later-described memory access unit 205 is sequentially requested to perform writing to the DRAM 107. Note that the start address of the write destination, which will be described later, the length of offset data transfer, the offset value, and the burst length are included in the address information.

Additionally, in the present embodiment, RDDMACs (Read Direct Memory Access Controllers) 207 through 210 read out image data to be used in the processing of the second signal processing unit 108 and the face detection unit 110. The RDDMACs are used as described below.
RDDMAC 207: reads out ×1 data
RDDMAC 208: reads out ×½ data
RDDMAC 209: reads out ×¼ data
RDDMAC 210: reads out face detection image data

The RDDMACs receive data readout address information regarding the DRAM 107 from the CPU 101 similarly to a WRDMAC, and request the memory unit 205 to perform readout. Note that each RDDMAC outputs image data input from the memory access unit 205 by readout to the second signal processing unit 108 or the face detection unit 110 in units of 1 byte. Note that in the present embodiment, the second signal processing unit 108 executes so-called hierarchal processing that generates image data with 1024×768 pixels in which a unit pixel has an information capacity of eight bits by upsampling ×½ data and ×¼ data and compositing it with ×1 data. Additionally, image data for face detection is image data with 128×96 pixels in which a unit pixel has an information capacity of eight bits.

The memory access unit 205 performs access control for access to the DRAM 107 relating to data transfer. When the memory access unit 205 receives a DRAM 107 access request and access destination address information from a WRDMAC or an RDDMAC, it allows the request and issues a corresponding command to the DRAM 107.

Specifically, when the memory access unit 205 receives a write request from a WRDMAC, it determines whether or not a row address other than the designated row address is open in the requested bank. If another row address is open, the memory access unit 205 sets the requested bank to an idle state by issuing a PRE command with respect to the row address. Additionally, the memory access unit 205 determines whether or not the designated row address is open in the requested bank. If the designated row address is not open, the memory access unit 205 opens the designated row address by issuing an ACT command with respect to the row address. Then, after the designated row address enters an open state, the memory access unit 205 issues a WR command and receives data from the WRDMAC that received the request, and performs a write with respect to the DRAM 107.

Note that the memory access unit 205 performs processing similarly in a case in which a readout request is received from an RDDMAC. When this happens, the memory access unit 205 reads out data at the designated address through eight-burst transfer and inputs the read data to the RDDMAC from which the request was received.

Note that the memory access unit 205 includes an arbitration unit 206. If multiple DRAM 107 access requests are received in the same period, the arbitration unit 206 determines a DMAC whose request is to be allowed according to a pre-set priority regarding processes that perform memory access. Specifically, if a DMAC corresponding to a high-priority process is performing or will perform access, the arbitration unit 206 deters access by a DMAC corresponding to a low-priority process.

Data Access Timing Chart

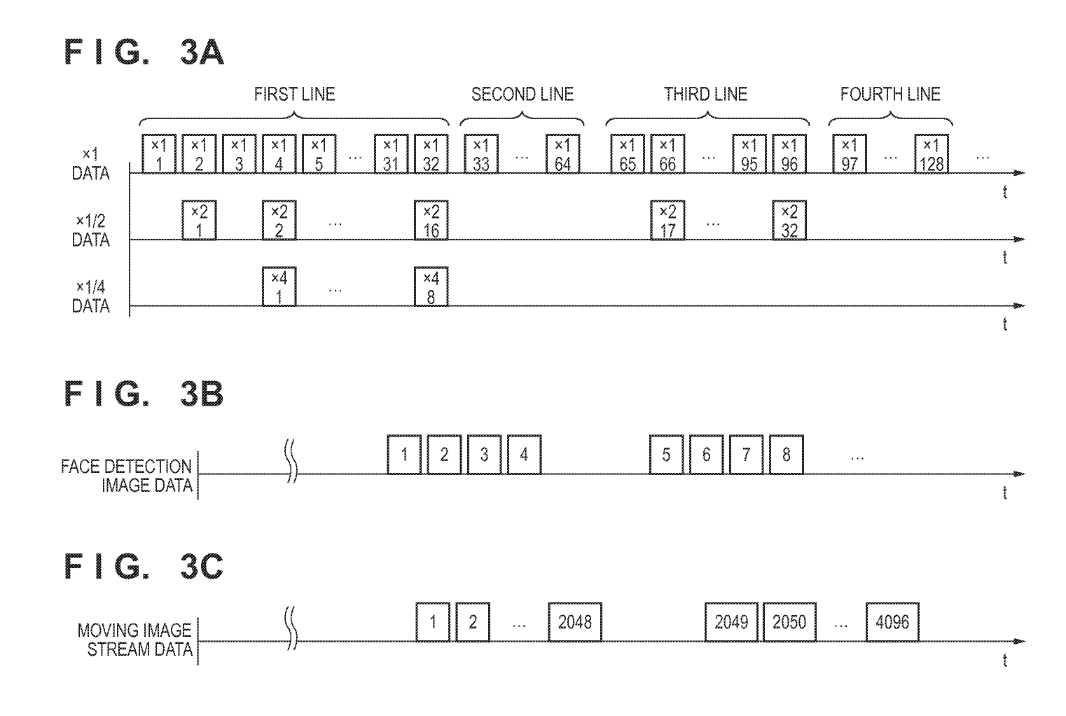

Here, a timing chart showing timing according to which DMACs of the present embodiment generate access requests with respect to the memory access unit 205 will be described with use of FIG. 3A to 3C.

During Hierarchal Processing

FIG. 3A shows a timing chart regarding the generation of write requests by WRDMACS in the case where a capture mode for generating image data that entails hierarchal processing is applied in the digital camera 100.

×1 data, ×½ data, and ×¼ data generated in the first signal processing unit 105 are sequentially input to the WRDMAC 201, the WRDMAC 202, and the WRDMAC 203, respectively, in the generation process. In the present embodiment, data processed in a raster scan pattern in the first signal processing unit 105 is sequentially transmitted to a WRDMAC. When input data has a data length corresponding to transfer through eight-burst transfer, in other words, when it is 32 bytes, the WRDMACs generate a write request for the memory access unit 205.

The 32-byte data to be transferred through eight-burst transfer is shown in FIG. 3A as one block. As described above, 1024 unit pixels, each having an info capacity of eight bits (one byte), are arranged in one horizontal line in the ×1 data. Because of this, a write request for one horizontal line is performed 1024÷32=32 times, and with the total image data, it is performed 32×768=24576 times. Additionally, a write request for one horizontal line of the ×½ data is performed 512÷32=16 times, and with the total image data, it is performed 16×384=6144 times. Additionally, a write request for one horizontal line of the ×¼ data is performed 256÷32=8 times, and with the total image data, it is performed 8×192=1536 times.

In other words, when the processing in the first signal processing unit 105 is performed in a raster scan pattern and the image data is sequentially input to the WRDMACs 201 through 203, the write requests generated by the WRDMACs are in the following relationship.
In the period of time up to and including when the write request of one block of the ×½ data is made, the write request of 2 blocks of ×1 data is made.
In the period of time up to and including when the write request of one block of the ×¼ data is made, two blocks of ×½ data and four blocks of ×¼ data are made.

Note that this is a case in which the first signal processing unit 105 is performing processing regarding a horizontal line that has pixels to be used in all of the data of ×1 data, ×½ data, and ×¼ data, and lines that do not contain pixels to be used are not limited to this.

During Face Detection

FIG. 3B shows a timing chart regarding the generation of read requests by the RDDMAC 210 in the case where a capture mode for generating image data that entails hierarchal processing is applied in the digital camera 100.

As described above, 128 pixels, each having an information capacity of 8 bits, are arranged in one horizontal line of image data for face detection. Because of this, when an image for face detection that was processed sequentially from the first signal processing unit 105 and stored in the DRAM 107 is read out sequentially one horizontal line at a time, the readout request for one horizontal line is performed 128÷32=4 times. Additionally, with the total image data, readout requests are performed 4×96=384 times.

During Moving Image Generation

FIG. 3C shows a timing chart relating to the generation of a write request by the WRDMAC 204 in the case where a capture mode for generating moving image stream data is applied in the digital camera 100.

The moving image generation unit 109 generates 32768 (=1024×1024/32) blocks-worth of stream data and sequentially inputs it to the WRDMAC 204. The WRDMAC 204 outputs a DRAM 107 write request to the memory access unit 205 for each block. Note that in the present embodiment, the moving image generation unit 109 generates moving image stream data for every 2048 blocks.

Access Control

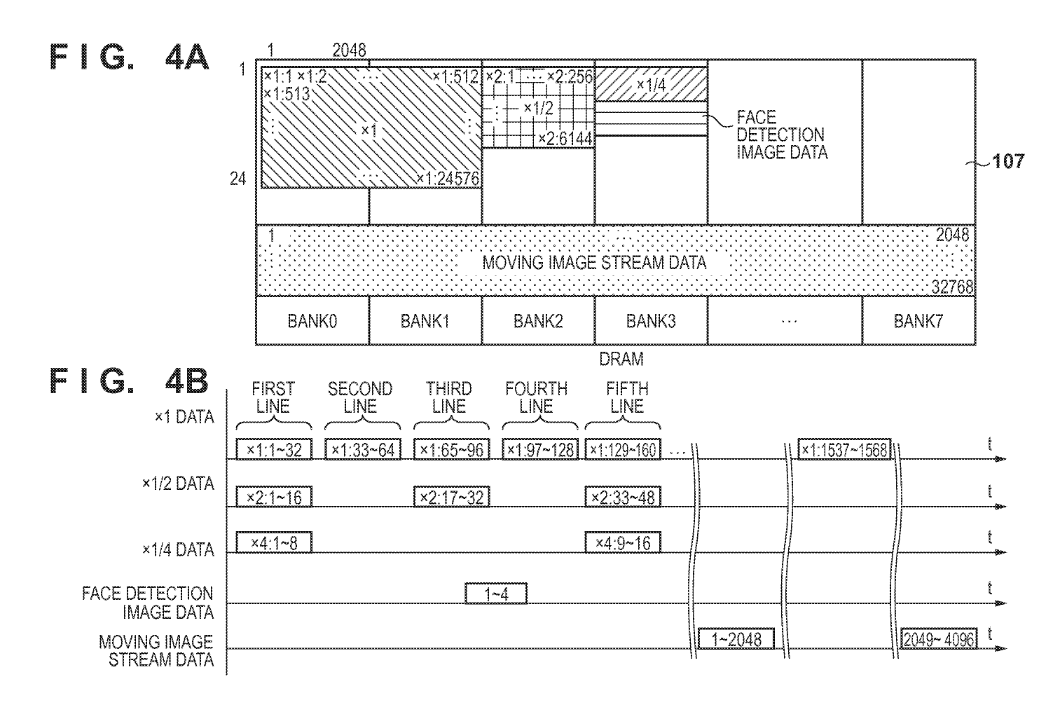

Below, access control regarding access to the DRAM 107, which is performed in the digital camera 100 of the present embodiment, will be described with use of FIGS. 4A and 4B.

In the present embodiment, the CPU 101 allocates a different bank for access to each of multiple processes in order to reduce the pre-charge frequency when access to the DRAM 107, which is performed alternatingly by the multiple processes, is performed repeatedly. Specifically, in accordance with the length of data to be transferred during a period in which processes can continuously access the DRAM 107 without being interrupted by other processes, the CPU 101 changes the bank address of each bank to be accessed by a process, as in FIG. 4A.

In the present embodiment, a case will be described in which generation processing, face detection processing, and moving image processing are simultaneously performed on image data entailing hierarchal processing. FIG. 4A shows banks that are allocated with respect to a process that accesses the DRAM 107 in the present embodiment. In the example in the diagram, BANKs 0 through 7 are allocated as banks for writing moving image stream data. Additionally, BANK 0 and BANK 1 are allocated as banks for writing ×1 data, BANK 2 is allocated as a bank for writing ×½ data, and BANK 3 is allocated as a bank for writing ×¼ data. Additionally, BANK 3, which is used for ×¼ data, is also allocated as a bank for writing (reading out) image data for face detection.

Note that during a writing of moving image stream data, after a write has been performed in all successive column addresses of the same row address in the order of BANK 0→BANK 1→ . . . →BANK 7, the row address subsequent to BANK 0 is opened and a write is similarly performed. Additionally, during a write of ×1 data, after a write has been performed in all successive column addresses of the same row address in the order of BANK 0→BANK 1, the row address subsequent to BANK 0 is opened and a write is similarly performed. During a writing of ×½ data, after a write has been performed in all successive column addresses of the same row address in BANK 2, the subsequent row address is opened and a write is similarly performed. Additionally, during a writing of ×¼ data or image data for face detection, after a write has been performed in all successive column addresses of the same row address in BANK 3, the subsequent row address is opened and a write is similarly performed.

FIG. 4B shows a period (access period) in which image data is written from each WRDMAC to the DRAM 107 of the present embodiment. In the present embodiment, the arbitration unit 206 of the memory access unit 205 sets processes relating to access of moving image stream data at a higher priority level than processes relating to access of other data. As shown in FIG. 4A, since moving image stream data is stored in all banks, data that is generated with other processes is stored in at least one of the banks in which moving image stream data is stored. Because of this, even when a DRAM 107 access request occurs with another process, the arbitration unit 206 can prohibit interruption by the access request by raising the priority for a process relating to access of moving image stream data. In other words, since processes that access the same bank occur alternatingly, that is to say, since a change of row address is not performed, the pre-charge command frequency can be reduced.

With ×1 data, ×½ data, and ×¼ data, which are generated by the first signal processing unit 105, the data lengths to be transferred during a period in which the DRAM 107 can be accessed continuously without being interrupted by other processes are shorter compared to that with moving image stream data. Because of this, every time 32 bytes of these three types of data is generated, an access request is made by each DMAC, and the arbitration unit 206 needs to alternatingly switch between processes in which the memory access unit 205 accesses the DRAM 107. However, in the present embodiment, since the various types of data are stored in different banks as shown in FIG. 4A, even when the process that performs access is switched, it is not necessary to return the bank to which an access is previously performed to an idle state, and the pre-charge frequency can be lowered.

Note that in the present embodiment, the data length of ×1 data to be transferred during a period when the DRAM 107 can be continuously accessed without being interrupted by other processes is longer than that of ×½ data and ×¼ data. Because of this, two banks, BANK 0 and BANK 1, of the DRAM 107 are allocated as the write destination for ×1 data. This is because while blocks of ×½ data and ×¼ data to be transferred are generated, blocks of ×1 data are continuously generated and written in the DRAM 107. In the present embodiment, since access relating to ×1 data is executed while interleaving multiple banks, access can be executed more efficiently.

Additionally, in order to reduce the pre-charge frequency, it is preferable that each of processes which perform writing to the DRAM 107 in parallel accesses to different bank. Depending upon the number of processes performing access to the DRAM 107, it is possible that the number of banks in the DRAM 107 will be insufficient. Specifically, if the DRAM 107 has eight banks, as in the present embodiment, although different banks can be allocated for up to and including eight processes, for any number of processes greater than that, a bank, to which other process is not allocated, cannot be allocated. Because of this, in the present embodiment, the write destination bank is shared if conditions for occurrence of DRAM 107 access requests that are performed in a process satisfy specific conditions as with ×¼ data and image data for face detection shown in FIG. 4A.

For example, the CPU 101 makes the following determination regarding data other than moving image stream data having a data length at or below a predetermined data length to be transferred during a period in which the DRAM 107 can be continuously accessed without being interrupted by other processes. The CPU 101 sets in advance the bank in which to store depending on whether or not the occurrence conditions of an access request of a process in which access relating to this type of data is performed satisfy the following conditions.
The total number of times of access to the DRAM 107 performed in the processing is at or below a pre-set number of times.
In the processing, the length of the period in which access to the DRAM 107 is not performed is greater than or equal to that of a pre-set period.

For example, as with ×¼ data, since the number of times a DRAM 107 access request is made by the WRDMAC 203 is small, being at most eight times in one horizontal line, the pre-charge frequency is low overall. Additionally, since ×¼ data is output only as one line out of four lines, a DRAM 107 access request is not performed for a period equating to a transfer of three horizontal lines-worth of data. In other words, since only two pre-charges are needed even if access relating to other data in the same bank continues for a period equating to a transfer three horizontal lines-worth of ×¼ data, there is little effect on the pre-charge frequency even if 2 or more processes are caused to access the same bank of the DRAM 107.

In the present embodiment, the number of banks in the DRAM 107 being accessed is suppressed while the pre-charge frequency is reduced due to writing ×¼ data and data for face detection in the same bank. Note that in the present embodiment, the arbitration unit 206 reduces the pre-charge frequency by setting the priority of a write request for ×¼ data from the WRDMAC 203 at a higher level than that of the read request for image data for face detection from the RRDMAC 210 and causing access of ×¼ data to continue.

In this way, the CPU 101 can increase the efficiency of access to the DRAM 107 by each process by changing the number of banks being interleaved according to the length of data being transferred during a period in which one process can continuously access the DRAM 107 without being interrupted by other processes. Additionally, when both a process with a high total number of access times and a process with short access intervals are allocated to the same bank, there is a high possibility that access will be performed in an alternating manner, and the pre-charge frequency will increase. In the present embodiment, the pre-charge frequency can be reduced by allocating these processes to different banks. Furthermore, with regard to processes with few total access times and processes with long access intervals, since there is a low possibility that access will be performed in an alternating manner even if allocated to the same bank, an increase in the pre-charge frequency can be reduced and the number of allocated banks can be saved by allocating these processes to the same bank.

Address Control Function

A method for controlling addresses so that a DMAC allocated to each process that can occur in parallel accesses only a specific bank of the DRAM 107 can be realized by an address control function included in each DMAC.

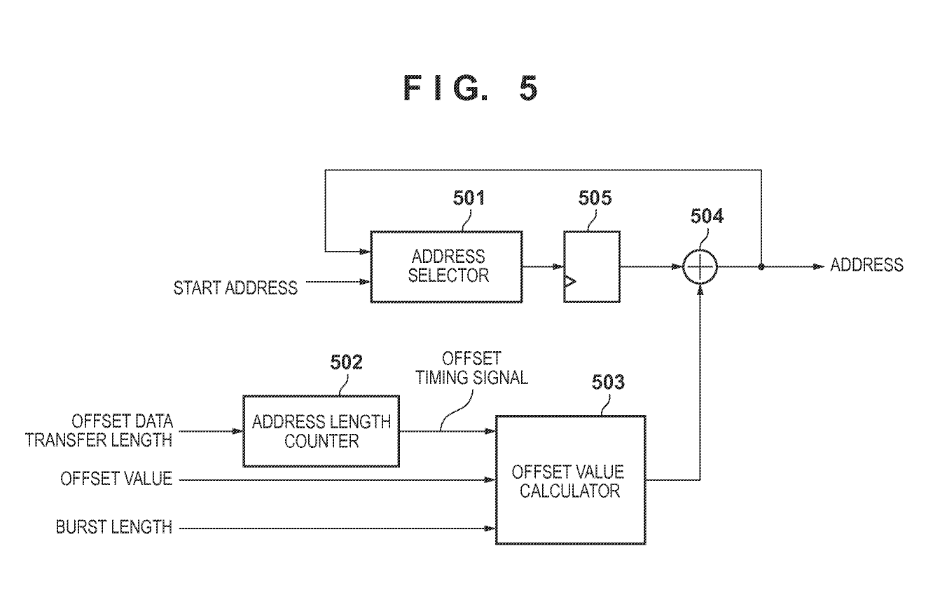

FIG. 5 is a block diagram for describing an address control function included in each DMAC of the present embodiment. The DMACs of the present embodiment have an offset function (address jump function) that causes the value of the data storage address to jump and change to a specific address when a predetermined amount of data is transferred. By utilizing the address jump function of this address control function, control can be performed so that data is written only in a specific bank, even when a write is performed during bank interleaving, as with ×1 data.

When address information (including start address, offset data transfer length, offset value, and burst length) is transmitted from the CPU 101, the following processing is performed in the DMACs and ultimately an address to be accessed is determined.

An address selector 501 selects the start address included in the address information at the start time of data access, and selects the address output by an adder 504, which will be described later, after access has started. The address includes the row address and column address, and in the case of ×1 data, the start address is (1,1). The address selected with the address selector 501 is held by a flip flop 505 and is output to the adder 504 at a predetermined timing.

When the length of data transferred from a DMAC reaches the offset data transfer length included in the address information, a transfer length counter 502 outputs a timing signal that indicates the offset timing to an offset value calculator 503. In the present embodiment, as shown in FIG. 4A, the offset data transfer length of ×1 data corresponds to the length of data of the column address from the head of BANK 0 to the end of BANK 1, which is 512 blocks (=16384 bytes).

When the offset value calculator 503 receives the offset timing signal from the transfer length counter 502, it outputs the offset value included in the address information. Additionally, the offset value calculator 503 outputs the burst length included in the address information at a timing other than that. In the present embodiment, the offset value is set such that the row address value after undergoing addition in the adder 504 is a value obtained by adding 1 to the current row address value, and such that the column address is the start column address. Note that in the present embodiment, the burst length is “8”.

Then, the adder 504 determines the address to be accessed by adding the value output by the offset value calculator 503 to the address held in the flip flop 505.

DRAM Transfer Sequence

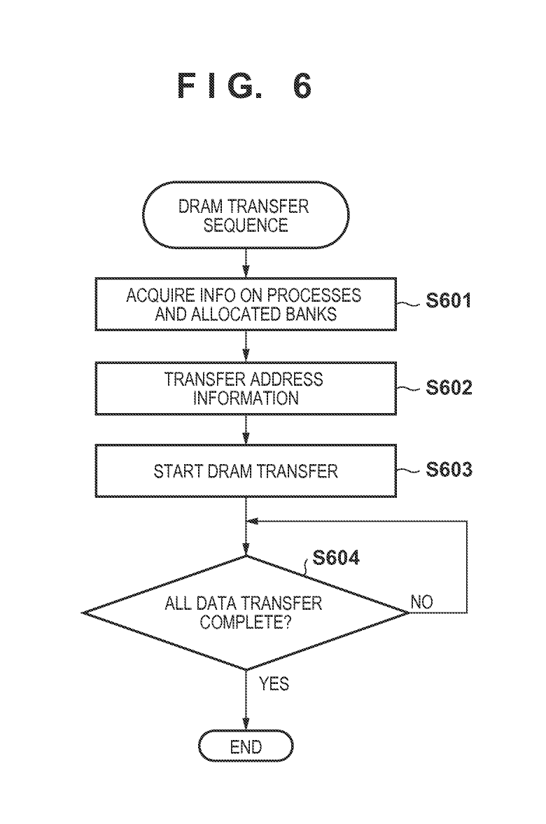

A specific process with regard to a DRAM transfer sequence of the digital camera 100 of the present embodiment with this configuration will be described with use of the flowchart in FIG. 6.

In step S601, the CPU 101 references capture mode information currently set in the digital camera 100 and obtains information relating to processes in which access to the DRAM 107 is performed, and relating to allocated banks.

In step S602, the CPU 101 transmits address information to each of the WRDMACs 201 through 204, and each of the RRDMACs 207 through 210. Specifically, the CPU 101, in accordance with information on processes in which access is performed and allocated banks, the CPU transmits pre-set information start address, offset data, transfer length, offset value, and burst length to a DMAC that performs data access for each process.

In step S603, the CPU 101 starts the execution of processes that involve data access to the DRAM 107. Then, the CPU 101 determines whether or not data access is complete in step S604. Specifically, the CPU 101 determines whether or not a control signal indicating that data access is complete was received from the transfer control unit 106. If the CPU 101 determines that the data access is complete, the CPU 101 terminates the sequence, and if it determines that the data access is not complete, the CPU 101 repeats the processing of the present step.

As described above, in the image processing apparatus of the present embodiment, even if multiple processes repeatedly access a DRAM alternatingly, data transfer efficiency can be improved by reducing the issue frequency of pre-charge commands.

Additionally, the image processing apparatus performs control in which the number of banks in the DRAM to be accessed by multiple processes is changed according to the combination of multiple processes in which parallel access to the DRAM is performed. That is to say, regarding processes having a smaller length of data to be transferred during a period in which a DRAM can be accessed continuously without being interrupted by other processes than a pre-set data length, even if the same bank as another process is allocated, the pre-charge frequency can be reduced. Because of this, an appropriate number of banks can be determined by ascertaining the combination. In other words, regarding the combination of multiple processes that perform parallel access to a DRAM, the image processing apparatus can determine the appropriate number of banks with reduced pre-charge frequency by ascertaining in advance the length of data to continuously undergo data access in each process.

Note that in the present embodiment, an example was described in which five types of data, namely ×1 data, ×½ data, ×¼ data, image data for face detection, and moving image stream data, are stored in a DRAM, but it is to be understood that the implementation of the present invention is not limited to this.

Additionally, in the present embodiment, a description was given in which moving image stream data is allocated to eight banks, ×1 data to two banks, and other image data to one bank, but the number of banks allocated for each type of data is not limited to this. It is sufficient that the number of banks allocated for each type of data is a number of banks in accordance with the magnitude relationship between continuously accessible data lengths.

Variation

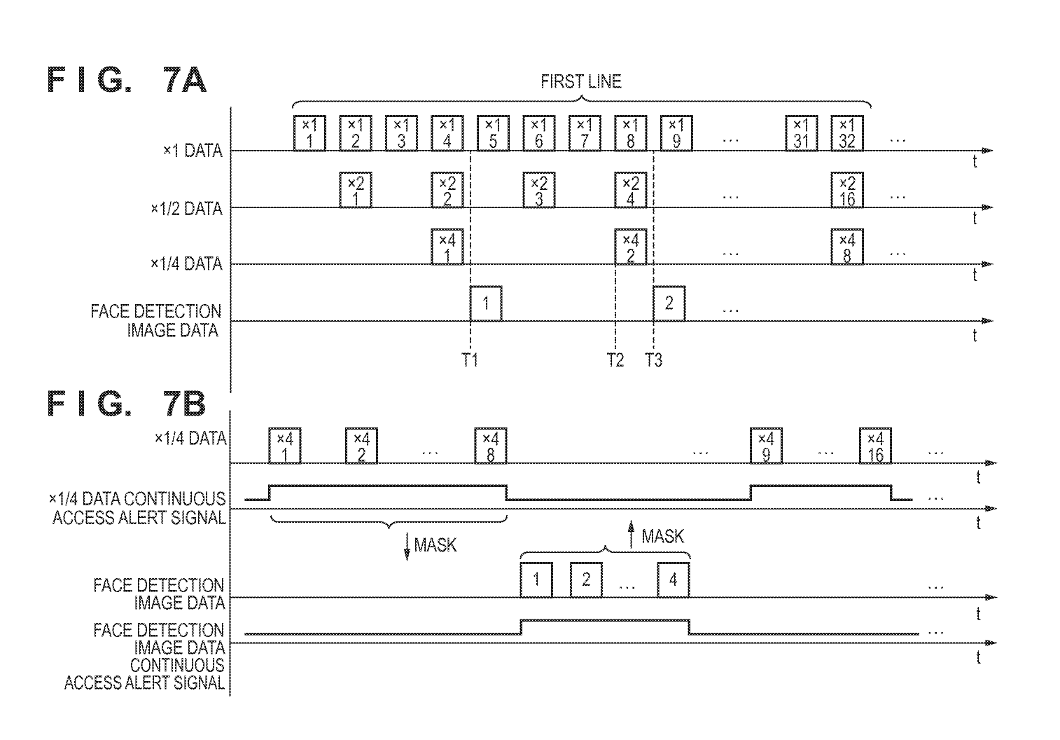

The above embodiment described a method of control such that a readout of image data for face detection, for example, is not executed when another process is performing access to the DRAM 107, by providing priority of access with respect to each process in which access to the DRAM 107 is performed. However, with the method of simply setting a priority level for processes, in the case where an access request is performed at timing T1 at which access relating to a writing of other image data is not being performed, as shown in FIG. 7A for example, other processes are not being executed and therefore, a readout is possible. In such a case, when a write of ×¼ data is performed in the same bank as the image data for face detection at timing T2, a pre-charge is necessary. Furthermore, at subsequent timing T3, when another readout of image data for face detection is performed, another pre-charge is necessary. That is to say, depending on the timing of a data access request, there is a possibility that access to a different row address in the same bank will occur alternatingly.

In contrast to this, in the present variation, if continuous data access is performed with respect to the DRAM 107 in a time interval that is shorter than a predetermined time interval, a signal reporting that access is underway is transmitted to the arbitration unit 206 of the memory access unit 205 while the access is being performed. Specifically, while data access relating to ×¼ data is being performed, a continuous access alert signal that is set to HIGH is transmitted from the WRDMAC 203 to the arbitration unit 206, as shown in FIG. 7B.

When the arbitration unit 206 receives the HIGH continuous access alert signal, it specifies the bank being accessed by the WRDMAC 203 that transmitted the signal, and it masks the access request made by the other DMAC (RDDMAC 210) to the specified bank. Note that when data transfer of an amount of data set by the CPU 101 (eight blocks: one horizontal line-worth) in which a write is continuously performed in an interval shorter than a predetermined time interval is complete, the WRDMAC 203 sets the continuous access alert signal to low.

Additionally, in a similar manner, while data access relating to image data for face recognition is being performed, as shown in FIG. 7B, a continuous access alert signal set to HIGH is transmitted from the RDDMAC 210 to the arbitration unit 206. Then, the RDDMAC 210 sets the continuous access alert signal to LOW upon the completion of data transfer of an amount of data set by the CPU 101 (four blocks) to be read continuously. At this time, the arbitration unit 206 masks the access request from the WRDMAC 203.

By doing this, in the case where multiple processes access the same bank, there is no interruption from other processes during a period in which one process performs continuous data access and therefore, the pre-charge frequency is reduced, and access can be performed efficiently.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-150778, filed Jul. 4, 2012, which is hereby incorporated by reference herein in its entirety.

What is claimed is:

1. An image processing apparatus for processing image data using a memory having a plurality of banks, comprising:
a processing unit configured to output a plurality of image data pieces having differing data amounts;
an allocating unit configured to allocate banks for storing the plurality of image data pieces output from the processing unit among the plurality of banks, the allocating unit allocating a different bank to each of the plurality of image data pieces;
a requesting unit configured to issue write requests for the plurality of image data pieces, based on the banks allocated by the allocating unit; and
a memory control unit configured to write the plurality of image data pieces to the memory according to the write requests issued by the requesting unit.

2. The image processing apparatus according to claim 1, wherein the allocating unit determines the number of banks to be allocated to one image data piece, according to the data amounts of the plurality of image data pieces.

3. The image processing apparatus according to claim 1, wherein the allocating unit determines the banks to be allocated to the plurality of image data pieces, based on the number of times the write requests for the plurality of image data pieces are issued in a predetermined period of time.

4. The image processing apparatus according to claim 3, wherein if the number of times that a write request for a predetermined image data piece is issued in the predetermined period is less than a predetermined value, the allocating unit allocates the same bank as a bank for another image data piece, as the bank for storing the predetermined image data piece.

5. The image processing apparatus according to claim 1, wherein the processing unit generates the plurality of image data pieces with use of image data acquired by an image capturing unit.

6. An image processing apparatus for processing image data using a memory having a plurality of banks, comprising:
an image capturing unit;
a processing unit configured to generate a plurality of image data pieces having differing data amounts, with use of image data acquired by the image capturing unit;
a moving image generating unit configured to generate moving image data with use of the image data acquired by the image capturing unit;
an allocating unit configured to allocate banks for storing the plurality of image data pieces output from the processing unit and the moving image data generated by the moving image generating unit among the plurality of banks, the allocating unit allocating a different bank to each of the plurality of image data pieces, and allocating the same banks as those of the plurality of image data pieces to the moving image data;
a requesting unit configured to issue write requests for the plurality of image data pieces, based on the banks allocated by the allocating unit; and
a memory control unit configured to write the plurality of image data pieces and the moving image data to the memory, according to the write requests issued by the requesting unit.

7. A control method of an image processing apparatus for processing image data using a memory having a plurality of banks, comprising:
a processing step of outputting a plurality of image data pieces having differing data amounts;
an allocating step of allocating banks for storing the plurality of image data pieces output in the processing step among the plurality of banks, different banks being allocated to the plurality of image data pieces;
a requesting step of issuing write requests for the plurality of image data pieces, based on the banks allocated in the allocating step; and
a memory controlling step of writing the plurality of image data pieces to the memory according to the write requests issued in the requesting step.

8. The method according to claim 7, wherein in the allocating step, the number of banks to be allocated to one image data piece is determined according to the data amounts of the plurality of the image data pieces.

9. The method according to claim 7, wherein in the allocating step, the banks to be allocated to the plurality of image data pieces are determined based on the number of times the write requests for the plurality of image data pieces are issued in a predetermined period of time.

10. The method according to claim 9, wherein in the allocating step, if the number of times that a write request for a predetermined image data piece is issued in the predetermined period of time is less than a predetermined value, the same bank as a bank for another image data piece is allocated as the bank for storing the predetermined image data piece.

11. The method according to claim 7, wherein in the processing step, the plurality of image data pieces are generated with use of image data acquired by an image capturing unit.

12. A control method of an image processing apparatus for processing image data using a memory having a plurality of banks, comprising:
an image capturing step;
a processing step of generating a plurality of image data pieces having differing data amounts with use of image data acquired in the image capturing step;
a moving image generating step of generating moving image data with use of the image data acquired in the image capturing step;
an allocating step of allocating banks for storing the plurality of image data pieces output in the processing step and the moving image data generated in the moving image generating step among the plurality of banks, a different bank being allocated to each of the plurality of image data pieces, and the same banks as those of the plurality of image data pieces being allocated to the moving image data;
a requesting step of issuing write requests for the plurality of image data pieces based on the banks allocated in the allocating step; and
a memory controlling step of writing the plurality of image data pieces and the moving image data to the memory according to the write requests issued in the requesting step.
